(19) United States
(12) Patent Application Publication
(10) Pub. No.: US 2008/0238839 A1
(43) Pub. Date: Oct. 2, 2008

(54) BACKLIGHT ASSEMBLY, DISPLAY DEVICE HAVING THE SAME AND METHOD OF DRIVING THE SAME

(75) Inventors: Gi-Cherl KIM, Yongin-si (KR); Young-Keun LEE, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/043,383

(22) Filed: Mar. 6, 2008

(30) Foreign Application Priority Data
Mar. 28, 2007 (KR) 10-2007-0030559

(51) Int. Cl. G09G 3/36; G09G 3/34; G09G 3/32

(52) U.S. Cl. 345/83; 345/84; 345/102

(57) ABSTRACT

A backlight assembly includes a plurality of line light source sections and a light source driving section. The line light source sections include a plurality of point light sources disposed along a first direction, and are disposed along a second direction substantially perpendicular to the first direction. The light source driving section controls each of the line light source sections to individually drive the point light sources. The light source driving section controls the line light source sections so that at least one of the line light source sections is sequentially driven along the second direction. Thus, the point light sources are individually activated within a required area, and are sequentially activated by at least every one line along the second direction, so that power consumption for driving the backlight assembly may be decreased.

This application claims priority to Korean Patent Application No. 2007-30559, filed on Mar. 28, 2007, and all the benefits accruing therefrom under 35 U.S.C. § 119, and the contents of which in its entirety are herein incorporated by reference.

### BACKGROUND OF THE INVENTION

1. Field of the Invention

The present invention relates to a backlight assembly, a display device having the backlight assembly and a method of driving the display device. More particularly, the present invention relates to a backlight assembly used for a display device, a display device having the backlight assembly and a method of driving the display device, which is capable of decreasing power consumption.

2. Description of the Related Art

In general, a liquid crystal display (“LCD”) device displays an image using liquid crystal that has optical characteristics, such as anisotropy of refractivity, and electrical characteristics, such as anisotropy of dielectric constant. The LCD device has various characteristics such as thinner thickness, lower driving voltage, lower power consumption, etc., than other types of display devices, such as a cathode ray tube (“CRT”) device, a plasma display panel (“PDP”) device, etc. Therefore, the LCD device is used in notebook computers, monitors, televisions, mobile phones, etc. The LCD device displays an image using optical and electrical properties of liquid crystal molecules, such as an anisotropic refractive index, and an anisotropic dielectric constant. The LCD device includes an LCD panel displaying an image using optical transmittance of liquid crystal molecules and a backlight assembly providing light to the LCD panel.

Generally, the LCD device typically has liquid crystal molecules with a slow response speed, so that an image having motion blur is displayed on the LCD panel. In order to decrease the motion blur, a backlight scanning technology has been developed. Here, the backlight scanning technology is a technology in which light sources of the backlight assembly are synchronized with the driving of the LCD panel to be repeatedly turned on/off.

However, the backlight scanning technology has low luminance in comparison with conventional technology that has continuously emitting light sources in the backlight assembly. Therefore, in order to obtain the same luminance with respect to the conventional technology, an overcurrent has to be applied to the light sources or the number of light sources has to be increased.

As a result, when the backlight assembly is driven by the backlight scanning technology, display quality is enhanced in comparison with the conventional technology. However, power consumption is increased in comparison with the conventional technology.

### BRIEF SUMMARY OF THE INVENTION

The present invention provides a backlight assembly capable of decreasing power consumption by enhancing a backlight scanning technology.

The present invention also provides a display device having the above-mentioned backlight assembly.

The present invention also provides a method of driving the above-mentioned display device.

In exemplary embodiments of the present invention, a backlight assembly includes a plurality of line light source sections and a light source driving part. The line light source sections may each include a plurality of point light sources disposed along a first direction. The line light source sections may be disposed along a second direction substantially perpendicular to the first direction. The light source driving part may control each of the line light source sections to individually drive the point light sources. The light source driving section may control the line light source sections so that at least one of the line light source sections is sequentially driven along the second direction.

In an exemplary embodiment, the light source driving part may individually drive the point light sources in response to a light source control signal generated through an analysis of external image data.

In an exemplary embodiment, each of the line light source sections may include a plurality of unit light-emitting groups arranged along the first direction. The unit light-emitting groups may include at least one of the point light sources.

Here, when each of the point light sources includes a red light-emitting diode (“LED”) emitting red light, a green LED emitting green light, and a blue LED emitting blue light, each of the unit light-emitting groups may include at least one of the red LEDs, at least one of the green LEDs, and at least one of the blue LEDs. Alternatively, each of the unit light-emitting groups may include at least one white LED emitting white light.

In an exemplary embodiment, when each of the unit light-emitting groups further includes at least one white LED emitting white light, the light source driving section may individually drive the unit light-emitting groups so that the point light sources of the unit light-emitting groups emit light of substantially the same luminance, in response to a light source control signal that is generated by analyzing external image data.

In other exemplary embodiments of the present invention, a display device includes a timing controller, a display unit and a backlight assembly. The timing controller outputs an image control signal and a light source control signal in response to an external signal applied from an external device. The display unit displays an image in response to the image control signal. The backlight assembly provides the display unit with light in response to the light source control signal.

The backlight assembly may include a plurality of line light source sections and a light source driving part. The line light source sections may each include a plurality of point light sources disposed along a first direction. The light source sections may be disposed along a second direction substantially perpendicular to the first direction. The light source driving part may control each of the line light source sections to individually drive the point light sources. The light source driving section may control the line light source sections so that at least one of the line light source sections is sequentially driven along the second direction.

In an exemplary embodiment, the timing controller may include an image analysis part that is synchronized with the image control signal to output the light source control signal corresponding to image data included in the external signal. In response to the light source control signal corresponding to the image data, some of the point light sources may not be driven by the light source driving section to reduce power consumption.

In still other exemplary embodiments of the present invention, a method of driving a display device includes applying an external signal to the display device, the display device including a plurality of line light source sections each having a plurality of point light sources disposed along a first direction. The line light source sections are disposed along a second direction substantially perpendicular to the first direction. Then, a light source control signal is generated by analyzing image data of the external signal. Then, the point light sources are individually activated in response to the light source control signal, and then sequentially activated at least one of the line light source sections along the second direction.

In an exemplary embodiment, an image control signal may be outputted in response to the external signal. Then, an image may be displayed on a display unit in response to the image control signal. Here, the light source control signal and the image control signal may be synchronized with each other.

In displaying the image on the display unit, an image drive signal may be outputted through an image driving section of the display unit in response to the image control signal, and then the image may be displayed on a display panel of the display unit in response to the image drive signal.

In displaying the image on the display panel of the display unit, an image may be displayed in a display area corresponding to at least one line light source section that is activated. Then, a light transmittance ratio of a liquid crystal layer of the display panel corresponding to an interference area adjacent to the display area may be decreased.

According to the present invention, point light sources are individually activated within a required area, and are sequentially activated by at least every one line along the second direction, so that power consumption for driving the backlight assembly may be decreased.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a block diagram schematically illustrating an exemplary display device according to an exemplary embodiment of the present invention;

FIG. 2 is a plan view schematically illustrating an exemplary light source unit of an exemplary backlight assembly according to an exemplary embodiment of FIG. 1;

FIG. 3 is a plan view schematically illustrating an image according to a first exemplary embodiment displayed on the exemplary display device of FIG. 1;

FIGS. 4A, 4B and 4C are plan views schematically illustrating the driving step of the exemplary light source unit of FIG. 2 for displaying an image of FIG. 3;

FIG. 5 is a plan view illustrating a displayed state of an image on a portion of the exemplary display screen of the exemplary display device of FIG. 1;

FIG. 6 is a plan view schematically illustrating an image according to a second exemplary embodiment displayed on the exemplary display device of FIG. 1;

FIGS. 7A, 7B and 7C are plan views schematically illustrating the driving step of the exemplary light source unit of FIG. 2 for displaying an image of FIG. 6;

FIGS. 8A and 8B are plan views schematically illustrating an exemplary unit light-emitting group according to another exemplary embodiment of the exemplary light source unit of FIG. 2;

FIG. 9 is a plan view schematically illustrating an exemplary light source unit of the exemplary backlight assembly according to another exemplary embodiment of FIG. 1;

FIG. 10 is a waveform diagram illustrating a relationship between a scan of the exemplary backlight assembly and a scan of the exemplary display panel of FIG. 9; and

FIG. 11 is a waveform diagram illustrating pulse width modulation (“PWM”) signals that are applied to each exemplary light source block, when a first channel signal has a high level.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

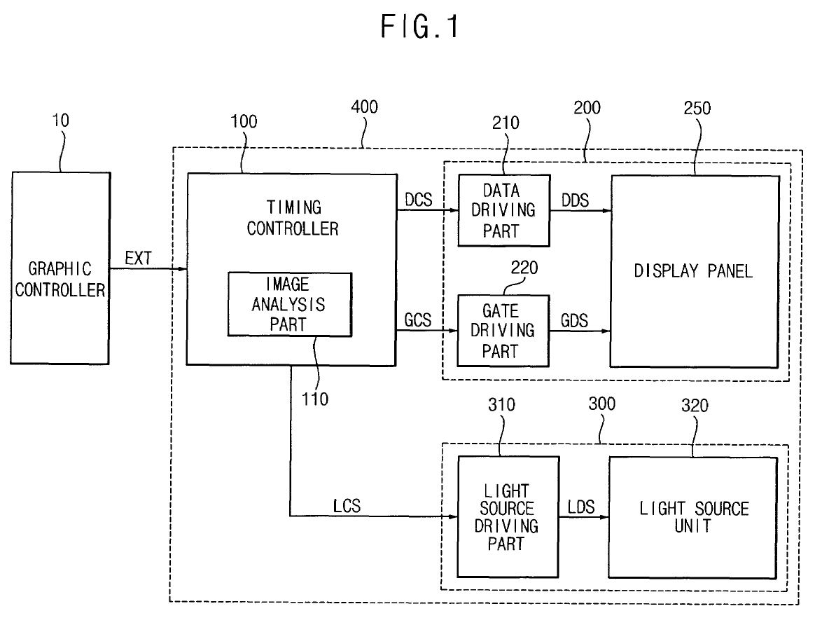

FIG. 1 is a block diagram schematically illustrating a display device 400 according to an exemplary embodiment of the present invention.

Referring to FIG. 1, the display device 400 according to exemplary embodiments of the present invention includes a timing controller 100, a display unit 200 and a backlight assembly 300.

The timing controller 100 receives an external signal EXT from an external device such as a graphic controller 10, and outputs an image control signal and a light source control signal LCS in response to the external signal EXT. The image control signal includes a data control signal DCS and a gate control signal GCS.

The timing controller 100 may include an image analysis part 110 outputting the light source control signal LCS. The image analysis part 110 analyzes image data included in the external signal EXT to output the light source control signal LCS. Here, the light source control signal LCS is synchronized to the image control signal, that is, the data control signal DCS and the gate control signal GCS. The light source control signal LCS is a signal corresponding to an analysis result of the image data included in the external signal EXT.

The display unit 200 receives the image control signal from the timing controller 100 and light from the backlight assembly 300, and displays an image. For example, the display unit 200 may include an image driving part and a display panel 250.

The image driving part receives the image control signal from the timing controller 100 and outputs the image drive signal to the display panel 250 in response to the image control signal. For example, the image driving part may include a data driving part 210 and a gate driving part 220. The data driving part 210 outputs a data drive signal DDS to the display panel 250 in response to the data control signal DCS applied from the timing controller 100. The gate driving part 220 outputs a gate drive signal GDS to the display panel 250 in response to the gate control signal GCS applied from the timing controller 100. That is, the image drive signal includes a data drive signal DDS and a gate drive signal GDS.

The display panel 250 is controlled by the image drive signal applied from the image driving part, that is, the data drive signal DDS and the gate drive signal GDS to display images using light provided from the backlight assembly 300.

The display panel 250 may include, for example, a first substrate (not shown), a second substrate (not shown) facing the first substrate and a liquid crystal layer (not shown) interposed between the first and second substrates.

The first substrate includes a signal line delivering the image drive signal, a thin-film transistor (“TFT”) electrically connected to the signal line and a pixel electrode electrically connected to the TFT. The pixel electrode may include a transparent conductive material. The signal line includes a gate line delivering the gate drive signal GDS and a data line delivering the data drive signal DDS.

The second substrate may include, for example, a color filter in correspondence with the pixel electrode and a common electrode formed on the substrate. The common electrode may include a transparent conductive material. The color filter may include, for example, a red color filter, a green color filter and a blue color filter.

The liquid crystal layer is interposed between the first and second substrates to be altered by an electric field formed between the pixel electrode and the common electrode. When the electric field is applied to the liquid crystal layer, an arrangement of liquid crystal molecules of the liquid crystal layer is altered to change optical transmissivity, so that an image is displayed.

The backlight assembly 300 may be disposed below the display unit 200. The backlight assembly 300 provides the display unit 200 with light in response to the light source control signal LCS applied from the timing controller 100. For example, the backlight assembly 300 may include a light source driving part 310 and a light source unit 320.

The light source driving part 310 receives the light source control signal LCS from the image analysis part 110 of the timing controller 100, and outputs the light source drive signal LDS to the light source unit 320 in response to the light source control signal LCS.

The light source unit 320 is controlled by the light source drive signal LDS applied from the light source driving part 310 to provide the display panel 250 with light.

The light source control signal LCS or the light source drive signal LDS may be a pulse width modulation (“PWM”) signal. Moreover, the light source control signal LCS or the light source drive signal LDS may be synchronized with the image control signal, that is the data control signal DCS and the gate control signal GCS, for controlling the display unit 200. For example, the light source control signal LCS, the light source drive signal LDS and the image control signal may be synchronized with at least one of the frequencies 60 Hz and 120 Hz.

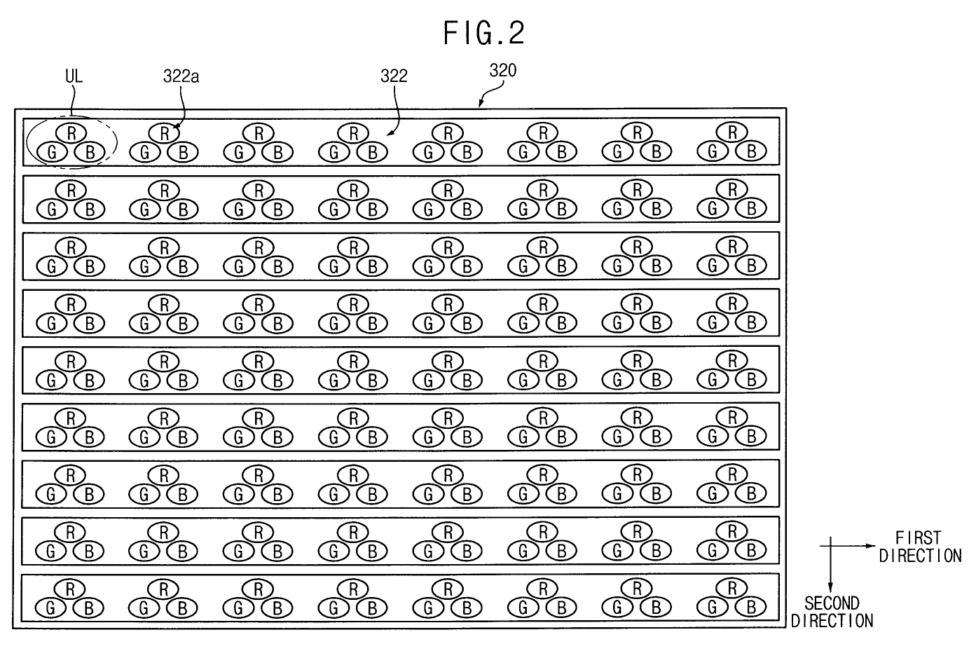

FIG. 2 is a plan view schematically illustrating the exemplary light source unit 320 of the exemplary backlight assembly 300 according to an exemplary embodiment of FIG. 1.

Referring to FIGS. 1 and 2, the light source unit 320 will be described in detail.

The light source unit 320 includes a plurality of line light source parts 322 having a long shape along a first direction, which are disposed in parallel along a second direction substantially perpendicular with the first direction. In other words, each line light source part longitudinally extends in the first direction. Each of the line light source parts 322 includes a plurality of point light sources 322a, for example, a plurality of color light sources, disposed along the first direction. Hereinafter, the same reference numerals will be used to refer to the color light sources as the point light source 322a.

The color light sources 322a emit a plurality of unit color lights to be individually controlled by the light source driving part 310. That is, the color light sources 322a are individually controlled by the light source driving part 310 in order to have substantially the same luminance level of the unit color lights or the different luminance levels of the unit color lights.

The color light sources 322a include, for example, a red light-emitting diode (“LED”) R emitting red light, a green LED G emitting green light and a blue LED B emitting blue light. One unit light-emitting group UL may be defined by at least one of the red LEDs R, at least one of the green LEDs G and at least one of the blue LEDs B. As a result, a plurality of the unit light-emitting groups ULs is arranged in at least one column in the first direction.

For example, each of the unit light-emitting groups ULs may include one red LED R, one green LED G and one blue LED B. The three LEDs R, G, B may be disposed in a triangle shape.

The line light source parts 322 are disposed parallel to each other along the second direction. The line light source parts 322 are controlled by the light source driving part 310 to be driven along at least one line along the second direction.

The gate line of the display panel 250 is formed along the first direction in parallel with each of the line light source parts 322, and the data line of the display panel 250 is formed along the second direction substantially perpendicular to each of the line light source parts 322. That is, a scanning direction of the light source unit 320 is perpendicular to an input direction of the gate drive signal GDS, and is substantially equal to an input direction of the data drive signal DDS.

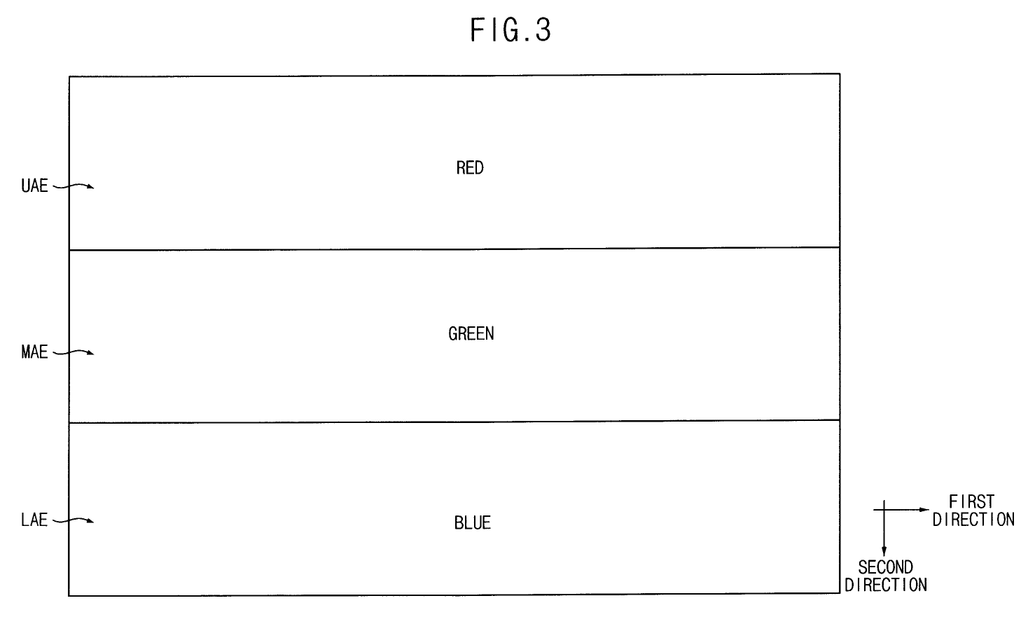

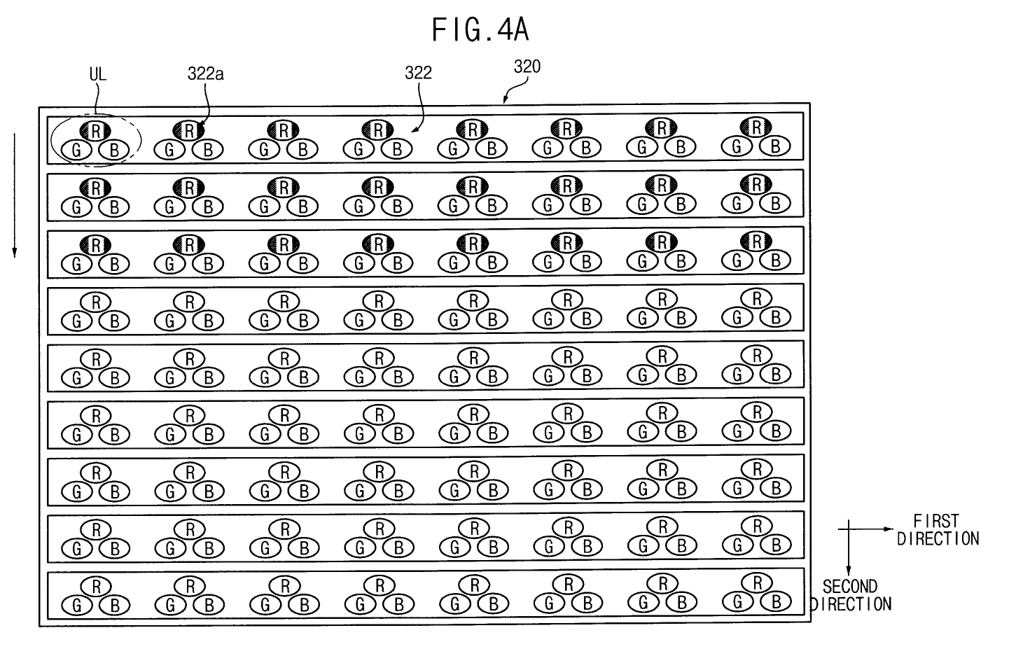

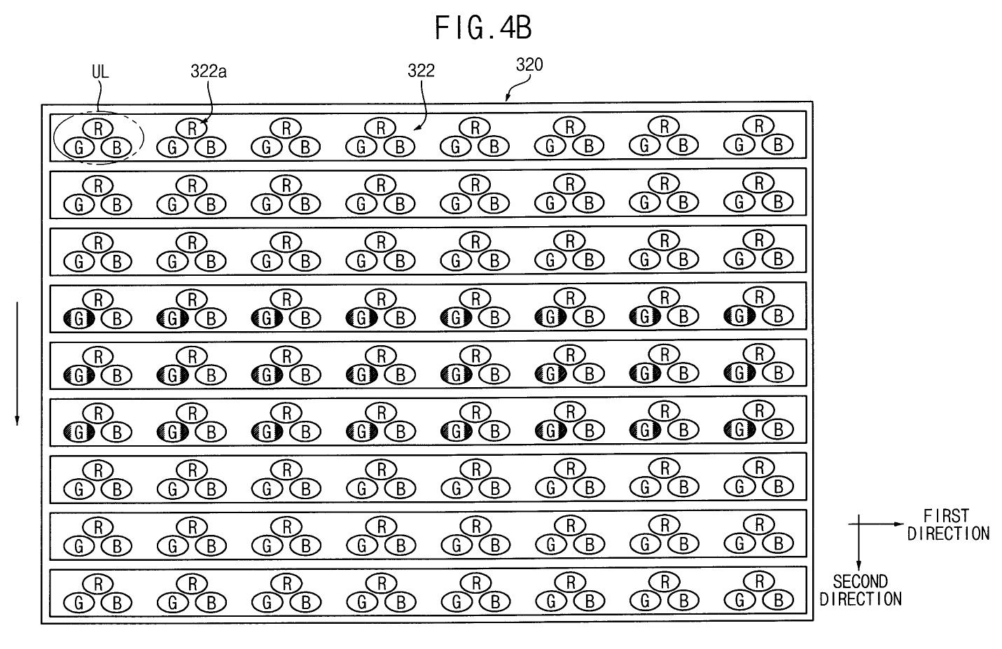

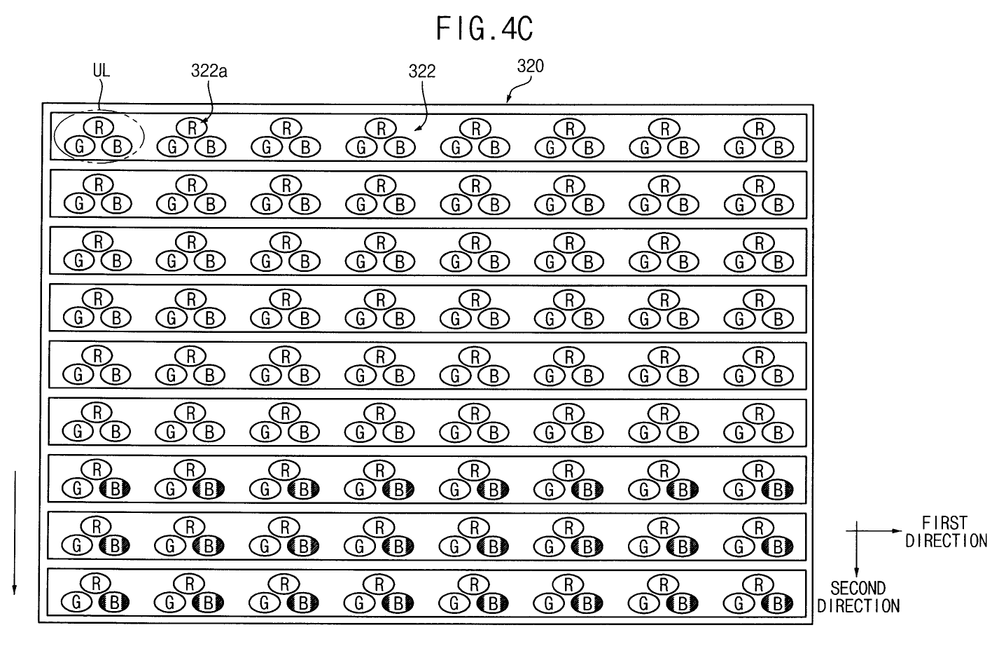

FIG. 3 is a plan view schematically illustrating an image according to an exemplary embodiment displayed on the exemplary display device 400 of FIG. 1. FIGS. 4A, 4B and 4C are plan views schematically illustrating the driving step of the exemplary light source unit of FIG. 2 for displaying an image of FIG. 3.

Referring to FIGS. 1, 3 to 4C, the display device 400 realizing an image according to an exemplary embodiment will be described.

An image according to an exemplary embodiment, which is displayed on the display device 400, includes an upper display area UAE, a middle display area MAE and a lower display area LAE along the second direction. Here, a red color image is displayed in the upper display area UAE, a green color image is displayed in the middle display area MAE, and a blue color image is displayed in the lower display area LAE.

In order to display the image on the display device 400 as shown in FIG. 3, the following processes will be performed.

The external graphic controller 10 outputs the external signal EXT including image data for displaying the image as shown in FIG. 3 to the timing controller 100.

The external signal EXT is applied to the timing controller 100. The timing controller 100 outputs the image control signal to the display unit 200, and outputs the light source control signal LCS to the backlight assembly 300. The image control signal and the light source control signal LCS are synchronization signals that are synchronized with a frequency of about 60 Hz or about 120 Hz.

Hereinafter, an outputting process of the light source control signal LCS will be described in detail. The external signal EXT is applied to the image analysis part 110 of the timing controller 100. The image analysis part 110 analyzes the image data included in the external signal EXT, and then provides the light source driving part 310 of the backlight assembly 300 with the light source control signal LCS corresponding to the analyzed result. Here, the image analysis part 110 may analyze the image data by every frame.

A process in which the image control signal controls the display unit 200 and a process in which the light source control signal LCS controls the backlight assembly 300 will be described separately.

The image control signal is applied to the image driving part of the display unit 200, and the image driving part provides the display panel 250 with the image drive signal in response to the image control signal. The display panel 250 realizes the image as shown in FIG. 3 in response to the image drive signal.

For example, the data control signal DCS of the image control signal is applied to the data driving part 210, and the data driving part 210 provides the display panel 250 with the data drive signal DDS of the image drive signal in response to the data control signal DCS. The gate control signal GCS of the image control signal is applied to the gate driving part 220, and the gate driving part 220 provides the display panel 250 with the gate drive signal GDS of the image drive signal in response to the gate control signal GCS.

The gate drive signal GDS is applied to the gate line of the display panel 250 to control the TFT. The data drive signal DDS is applied to the data line of the display panel 250 to be transmitted to the pixel electrode via the TFT. Accordingly, the display panel 250 is controlled by the gate drive signal GDS and the data drive signal DDS to realize the image as shown in FIG. 3 using light provided from the backlight assembly 300.

Then, a process in which the light source control signal LCS controls the backlight assembly 300 will be described. Here, the process in which the light source control signal LCS controls the backlight assembly 300 is simultaneously performed by synchronizing with a process in which the image control signal controls the display unit 200.

The light source control signal LCS generated from the image analysis part 110 is applied to the light source driving part 310 of the backlight assembly 300. The light source driving part 310 provides the light source unit 320 with the light source drive signal LDS for really driving the light source unit 320 in response to the light source control signal LCS. Here, the light source drive signal LDS may include a PWM signal capable of determining a luminance level of light.

When the light source drive signal LDS is applied to the light source unit 320, the color light sources (i.e., point light sources) 322a included in each of the line light source part 322 of the light source unit 320 are individually activated, and at least one of the line light source parts 322 is sequentially activated along the second direction.

Referring to FIGS. 4A to 4C, a driving process of the light source unit 320 will be described in detail.

Firstly, referring to FIGS. 3 and 4A, the red LEDs R of the color light sources 322a corresponding to the upper display area UAE are activated by at least every one line, in order to display the red image on the upper display area UAE of the display panel 250. In one exemplary embodiment, the red LEDs R arranged along three lines may be simultaneously activated. In another exemplary embodiment, the red LEDs R arranged along one line may be sequentially activated.

Then, referring to FIGS. 3 and 4B, in order to display the green color image through the middle display area MAE of the display panel 250, the green LEDs G of the color light sources 322a emits by at least every one line, which corresponds to the middle display area MAE. In one exemplary embodiment, the green LEDs G disposed along three lines may be simultaneously activated to emit green light. In another exemplary embodiment, the green LEDs G disposed along one line may be activated by every one line to sequentially emit green light.

Lastly, referring to FIGS. 3 and 4C, the blue LEDs B of the color light sources 322a corresponding to the lower display area LAE are activated by at least every one line, in order to display the blue image on the lower display area LAE of the display panel 250. In one exemplary embodiment, the blue LEDs B arranged along three lines may be simultaneously activated. In another exemplary embodiment, the blue LEDs B arranged along one line may be sequentially activated.

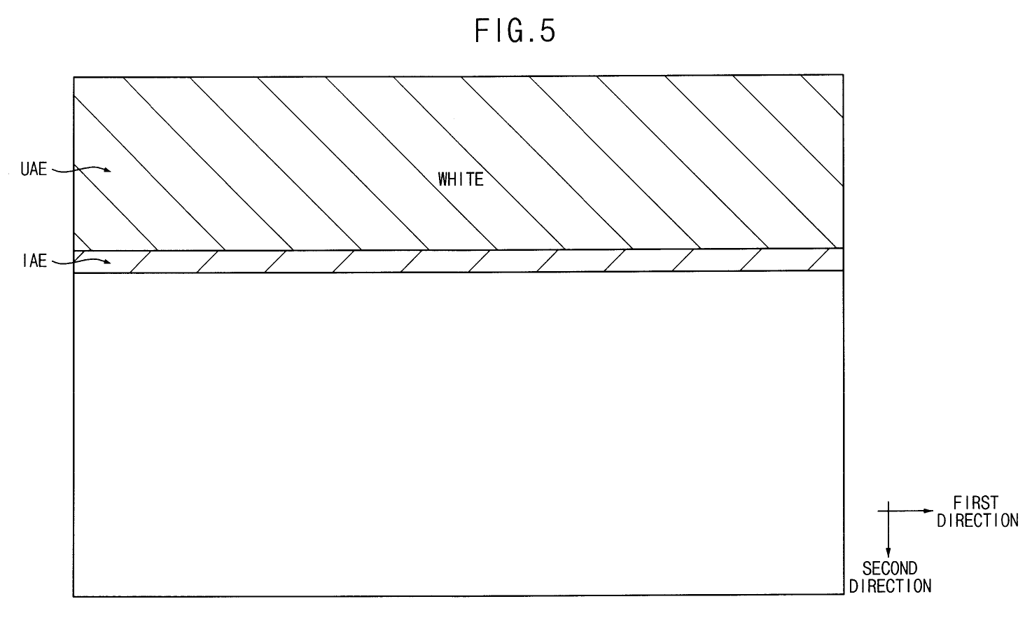

FIG. 5 is a plan view illustrating a displayed state of an image on a portion of the exemplary display screen of the exemplary display device of FIG. 1.

Referring to FIGS. 4A and 5, a white color image is displayed in the upper display area UAE of the display panel 250. That is, the red, green and blue LEDs corresponding to the upper display area UAE are simultaneously activated to emit white light, so that the white color light may realize the white color image.

However, the white color light may be provided to the upper display area UAE, and also may be provided to an interference area IAE adjacent to the upper display area UAE. Accordingly, when the white color light is provided to the interference area IAE, the display panel 250 may display a non-required image through the interference area IAE.

Therefore, in order to prevent the non-required image from being displayed in the interference area IAE, the liquid crystal layer may have a low light transmittance, which is disposed in the display panel 250 corresponding to the interference area IAE.

For example, when an image is realized through a portion of a display area of the display panel 250, the color light sources 322a corresponding to the display area may be activated. The light emitted through the color light sources 322a corresponding to the display area is provided to the interference area IAE adjacent to the display area. As a result, a non-required image may be displayed in the interference area IAE.

Therefore, the non-required image needs to be prevented from being displayed in the interference area IAE by decreasing the light transmittance of the liquid crystal layer corresponding to the interference area IAE. In one exemplary embodiment, the display panel 250 may be controlled to decrease the light transmittance of the liquid crystal layer corresponding to the interference area IAE so as to decrease the displaying of the non-required image in the interference area IAE.

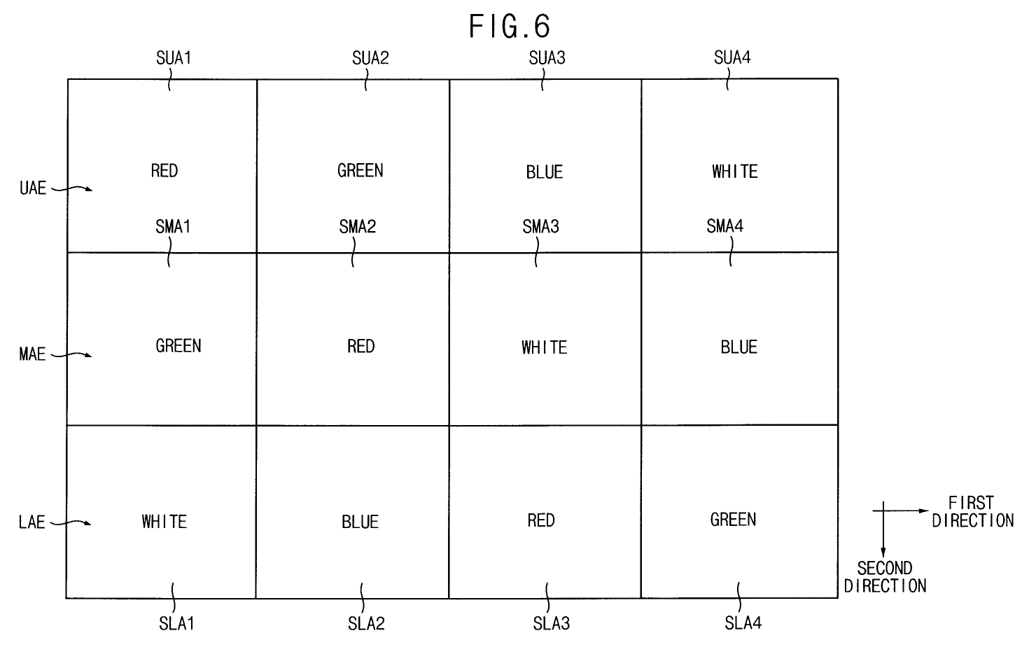

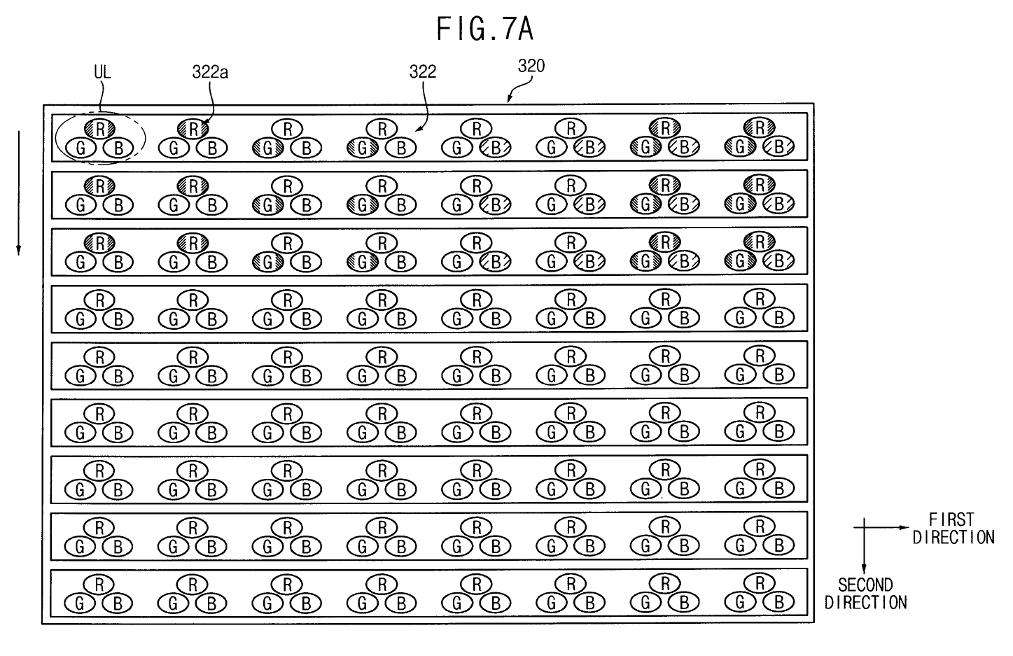

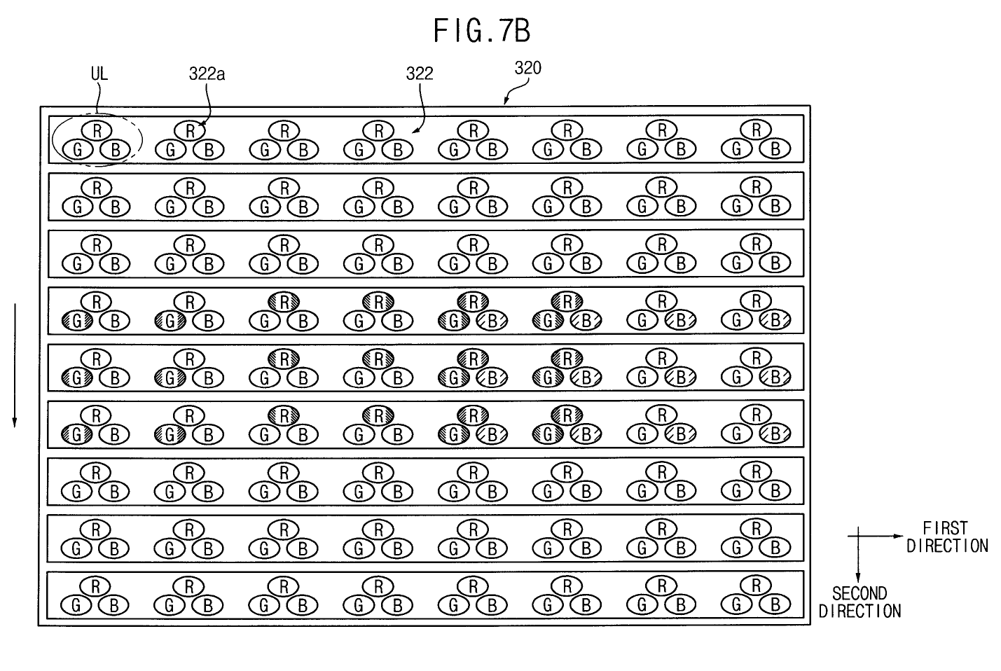

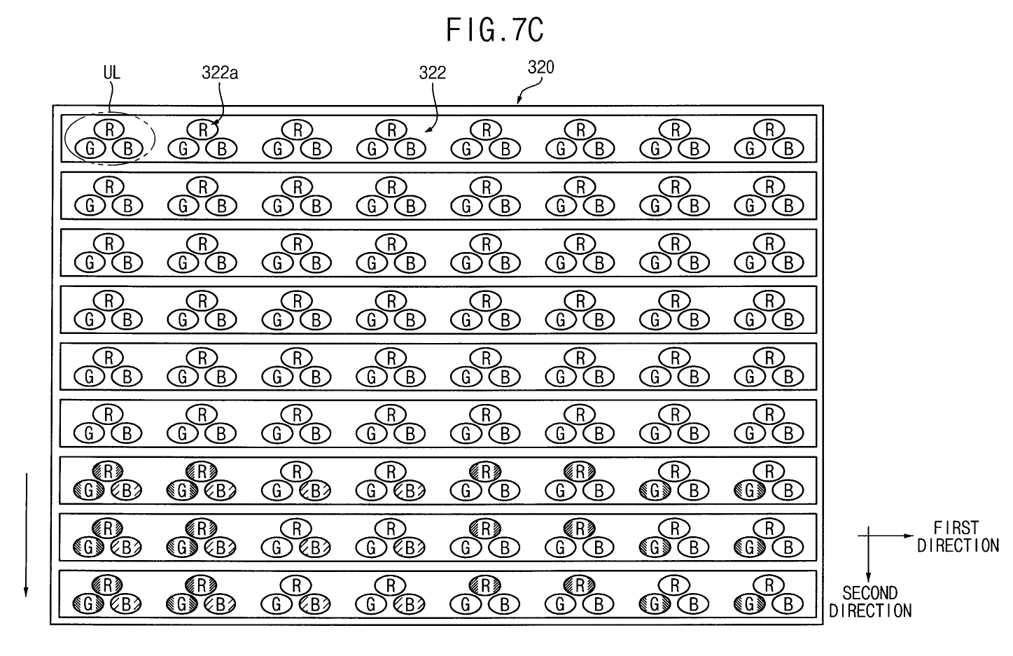

FIG. 6 is a plan view schematically illustrating an image according to a second exemplary embodiment displayed on the exemplary display device of FIG. 1. FIGS. 7A, 7B and 7C are plan views schematically illustrating the driving step of the exemplary light source unit of FIG. 2 for displaying an image of FIG. 6.

Referring to FIGS. 1, 6 and 7A to 7C, the display device 400 realizing an image according to another exemplary embodiment will be described.

An image according to another exemplary embodiment includes an upper display area UAE, a middle display area MAE and a lower display area LAE. The upper display area UAE includes a first sub-upper area SUAL, a second sub-upper area SUA2, a third sub-upper area SUA3 and a fourth sub-upper area SUA4 along the first direction. The middle display area MAE includes a first sub-middle area SMA1, a second sub-middle area SMA2, a third sub-middle area SMA3 and a fourth sub-middle area SMA4 along the first direction. The lower display area LAE includes a first sub-lower area SLA1, a sub-second sub-lower area SLA 2, a third sub-lower area SLA 3 and a fourth sub-lower area SLA 4 along the first direction.

A red image is displayed in the first sub-upper area SUAL, a green image is displayed in the second sub-upper area SUA2, a blue image is displayed in the third sub-upper area SUA3, and a white image is displayed in the fourth sub-upper area SUA4.

A green image is displayed in the first sub-middle area SMA1, a red image is displayed in the second sub-middle area SMA2, a white image is displayed in the third sub-middle area SMA3, and a blue image is displayed in the fourth sub-middle area SMA4.

A white image is displayed in the first sub-lower area SLA1, a blue image is displayed in the second sub-lower area SLA2, a red image is displayed in the third sub-lower area SLA3, and a green image is displayed in the fourth sub-lower area SLA4.

Referring to FIGS. 7A to 7C, a driving process of the light source unit 320 in order to display an image as shown in FIG. 6 will be described. Here, driving processes of the display device are substantially the same as the driving processes described with respect to FIGS. 1, 3, and 4A to 4C except for a driving process of the light source unit 320, and therefore repetitive descriptions will be omitted.

Firstly, referring to FIGS. 6 and 7A, in order to display each of the red, green, blue and white color images in the first, second, third and fourth sub-upper areas SUA1, SUA2, SUA3 and SUA4, respectively, the red LEDs R of the color light sources 322a corresponding to the first sub-upper area SUAL are activated by at least every one line. Moreover, the green LEDs G of the color light sources 322a corresponding to the second sub-upper area SUA2 are activated by at least every one line, and the blue LEDs B of the color light sources 322a corresponding to the third sub-upper area SUA3 are activated by at least every one line. Moreover, all of the red, green and blue LEDs R, G and B of the color light source 322a corresponding to the fourth sub-upper area SUA4 are activated by at least every one line.

Then, referring to FIGS. 6 and 7B, in order to display each of the green, red, white and blue color images in the first, second, third and fourth sub-middle areas SMA1, SMA2, SMA3 and SMA4, respectively, the green LEDs G of the color light sources 322a corresponding to the first sub-middle area SMAL are activated by at least every one line. Moreover, the red LEDs R of the color light source 322a corresponding to the second sub-middle area SMA2 are activated by at least every one line, and all of the red, green and blue LEDs R, G and B of the color light sources 322a corresponding to the third sub-middle area SMA3 are activated by at least every one line. Moreover, the blue LEDs B of the color light sources 322a corresponding to the fourth sub-middle area SMA4 are activated by at least every one line.

Referring to FIGS. 6 and 7C, in order to display each of the white, blue, red and green color images in the first, second, third and fourth sub-lower areas SLA1, SLA2, SLA3 and SLA4, respectively, all of the red, green and blue LEDs R, G and B of the color light sources 322a corresponding to the first sub-lower area SLA1 are activated by at least every one line. Moreover, the blue LEDs B of the color light sources 322a corresponding to the second sub-lower area SLA2 are activated by at least every one line, and the red LEDs R of the color light sources 322a corresponding to the third sub-lower area SLA3 are activated by at least every one line. Moreover, the green LEDs G of the color light sources 322a corresponding to the fourth sub-lower area SLA4 are activated by at least every one line.

Accordingly, the color light sources 322a included in each line light source part 322 of the light source unit 320 are individually activated, and at least one of the line light source parts 322 are sequentially activated along the second direction.

For example, the unit light-emitting groups ULs included in each of the line light source parts 322 may be individually activated to each other, and the color light sources 322a included in one of the unit light-emitting groups ULs may be individually activated to each other. For example, the color light sources 322a included in one of the unit light-emitting groups UL may emit unit color lights having substantially the same luminance level. Alternatively, the color light sources 322a included in one of the unit light-emitting groups UL may emit unit color light having different luminance levels from each other.

A light-emitting area emitted by at least every one line due to the line light source parts 322 may be moved by every one line along the second direction. For example, the light-emitting area may be moved along the second line by every one line to be synchronized with a frequency of about 60 Hz or about 120 Hz.

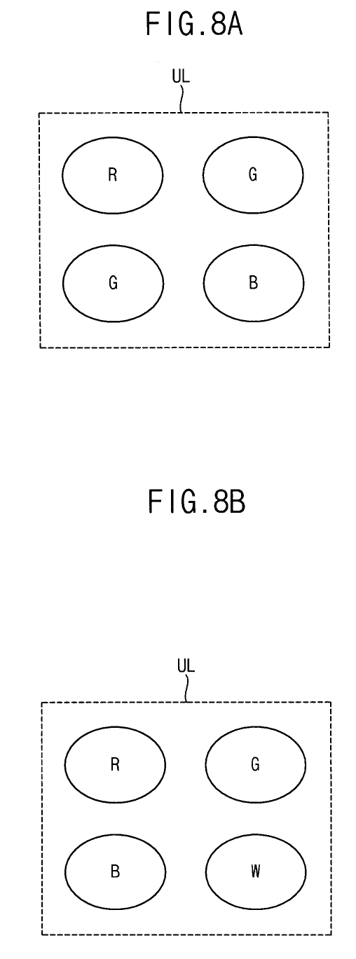

FIGS. 8A and 8B are plan views schematically illustrating an exemplary unit light-emitting group according to another exemplary embodiment of the light source unit of FIG. 2.

Referring to FIGS. 8A and 8B, the unit light-emitting group UL includes one red LED R, two green LEDs G and one blue LED B. Alternatively, the unit light-emitting group UL may include one red LED R, one green LED G, one blue LED B and one white LED W. For example, the four LEDs may be disposed in a rectangular shape.

Accordingly, when a predetermined image is displayed in a portion area of the display panel 250, the predetermined image is analyzed. Then, the color light sources 322a are individually activated within the portion area to correspond with the analyzed result, so that power consumption may be decreased in comparison with the conventional art where all of the color light sources 322a are activated within the portion area.

For example, when a red image is realized through the portion area of the display panel 250, the red LEDs R of the color light sources 322a corresponding to the portion area may be activated, so that power consumption may be decreased in comparison with the conventional art where all of the color light sources 322a are activated within the portion area.

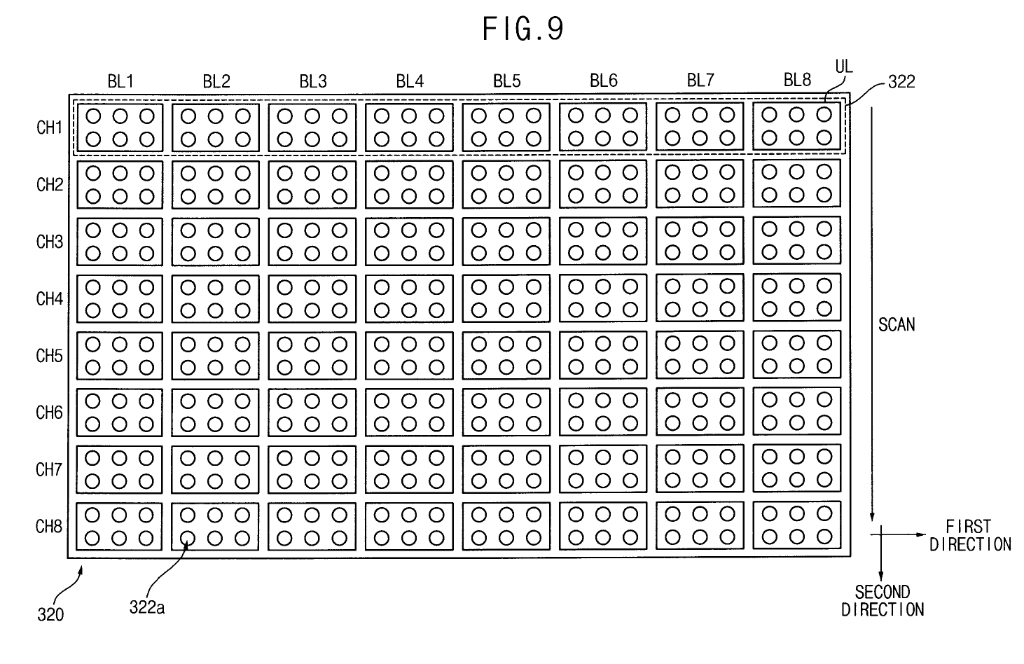

FIG. 9 is a plan view schematically illustrating an exemplary light source unit of the exemplary backlight assembly according to another exemplary embodiment of FIG. 1.

Referring to FIGS. 1 and 9, a driving process of the exemplary light source unit 320 according to another exemplary embodiment will be described in detail.

The light source unit 320 includes a plurality of line light source parts 322 that is extended along the first direction. The line light source parts 322 are disposed in parallel with the second direction. For example, the light source unit 320 may include eight line light source parts 322 that are disposed along the second direction. The eight line light source parts 322 may correspond to a first scan area CH1, a second scan area CH2, a third scan area CH3, a fourth scan area CH4, a fifth scan area CH5, a sixth scan area CH6, a seventh scan area CH7 and an eighth scan area CH8, respectively. The first to eighth scan areas CH1 to CH8 will be described as follows.

Each of the line light source parts 322 includes a plurality of unit light-emitting groups ULs that are disposed along the first direction. Each of the unit light-emitting groups UL includes at least one point light source 322a.

For example, each of the line light source parts 322 may include eight unit light-emitting groups UL. Each of the eight unit light-emitting groups UL includes six point light sources 322a. The six point light sources 322a are arranged in two rows extending in the first direction and three columns extending in the second direction. The eight unit light-emitting groups UL correspond to a first light source block BL1, a second light source block BL2, a third light source block BL3, a fourth light source block BL4, a fifth light source block BL5, a sixth light source block BL6, a seventh light source block BL7 and an eighth light source block BL8, respectively. As a result, the point light sources 322a are disposed in sixteen rows and twenty-four columns.

The point light sources 322a may include a plurality of white LEDs emitting white light. The point light sources 322a are individually controlled by the light source driving part 310. For example, the point light sources 322a are provided in the unit light-emitting groups UL so that the point light sources 322a of each of the unit light-emitting groups UL emit light having substantially the same luminance level. That is, the point light sources 322a that are disposed in one of the unit light-emitting groups UL may emit light having an identical luminance level, and the point light sources 322a that are disposed in another of the unit light-emitting groups UL may emit light having substantially the same luminance level or emit light having luminance levels different from each other.

The line light source parts 322 are sequentially driven along the second direction by at least every one line due to the light source driving part 310. Moreover, the line light source parts 322 are driven by the light source driving part 310, so that at least one light-emitting line emitted from the line light source parts 322 is controlled to be moved by every one line along the second line.

Referring to FIGS. 1 and 9, a driving process in which an image is displayed on the display device 400 will be described in detail.

The graphic controller 10 outputs an external signal EXT including image data to the timing controller 100.

The timing controller 100 outputs the image control signal, including the data control signal DCS and the gate control signal GCS, to the display unit 200 in response to the external signal EXT, and outputs the light source control signal LCS to the backlight assembly 300.

The image analysis part 110 of the timing controller 100 performs analysis of the image data included in the external signal EXT, and outputs the light source control signal LCS corresponding to the analysis result to the light source driving part 310 of the backlight assembly 300. The image analysis part 110 may perform an analysis on the image data included in the external signal EXT by every frame.

For example, the image analysis part 110 performs an analysis on the image data by every frame, and calculates each luminance level required to realize an image corresponding to the unit light-emitting groups UL. The image analysis part 110 outputs the light source control signal LCS having information for each of the luminance levels to the light source driving part 310.

The light source driving part 310 outputs the light source drive signal LDS for driving the light source unit 320 to the light source unit 320 in response to the light source control signal LCS.

The light source unit 320 individually drives the unit light-emitting groups UL such that the point light sources 322a of each of the unit light-emitting groups UL emits light of substantially the same luminance, so that the line light source parts 322 are sequentially driven by at least every one line along the second direction. As a result, the point light sources 322a may emit light, each of the point light sources 322a emitting light having the luminance that is required to realize the image portions by each of the unit light-emitting groups UL.

The image control signal, including the data control signal DCS and the gate control signal GCS, is applied to the image driving part of the display unit 200. The image driving part, including the data driving part 210 and the gate driving part 220, outputs the image drive signal, including the data drive signal DDS and the gate drive signal GDS, to the display panel 250 in response to the image control signal. The display panel 250 may display images using light provided from the backlight assembly 300 in response to the image drive signal.

Referring to FIGS. 1 and 9, an effect of the display device 400 as described in FIGS. 1 and 9 will be described.

The point light sources 322a of the unit light-emitting groups UL, which correspond to an image portion displaying a black image, are controlled to not emit light, and the point light sources 322a of the unit light-emitting groups UL, which correspond to an image portion displaying a white image, are controlled to emit light having a maximum luminance. Moreover, point light sources 322a of the unit light-emitting groups UL, which correspond to an image portion displaying a grey image, are controlled to emit light having a luminance somewhere between no luminance and a maximum luminance, such as a middle luminance.

Accordingly, each of the luminance levels required to realize the image portions is calculated by analyzing the image data contained in the external signal EXT, and then the point light sources 322a are emitted by the unit light-emitting groups UL to each emit the calculated luminance light, so that power consumption of the display device 400 may be decreased. Furthermore, a darkness ratio of the image may be increased.

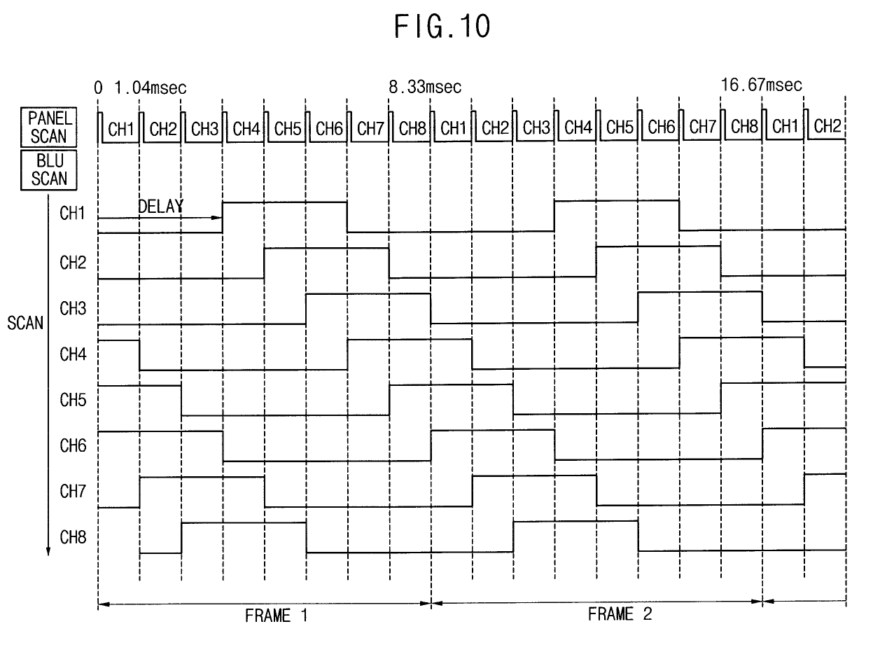

FIG. 10 is a waveform diagram illustrating a relationship between a scan of the backlight assembly 300 of FIG. 9 and a scan of the display panel 250. That is, FIG. 10 shows an exemplary embodiment of a relationship between a scan timing of the backlight assembly 300 and a scan timing of the display panel 250, when light is generated in the first to eight scan areas CH1, CH2, CH3, CH4, CH5, CH6, CH7 and CH8 of FIG. 9.

Referring to FIGS. 1, 9 and 10, when the display device 400 displays an image during one frame, light is sequentially emitted from the first to eighth scan areas CH1, CH2, CH3, CH4, CH5, CH6, CH7 and CH8. Here, when the light source control signal LCS and the image control signal are synchronized with a frequency of about 120 Hz, each of one frame and ⅛ of a frame is about 8.33 ms and about 1.04 ms, respectively.

For example, light is emitted from each of the first to eighth scan areas CH1, CH2, CH3, CH4, CH5, CH6, CH7 and CH8 during ⅜ of a frame (i.e., about 3.12 ms). The light emitted from each of the first to eighth scan areas CH1, CH2, CH3, CH4, CH5, CH6, CH7 and CH8 are delayed by about ⅛ of a frame along the second direction to be radiated toward an external side. As a result, a light-emitting line, which is a light group generated from the light source unit 320, may be moved by every one line along the second direction by every ⅛ of a frame to be emitted.

The light source control signal LCS is synchronized with the image control signal. In one exemplary embodiment, the light source control signal LCS is synchronized with a frequency of about 120 Hz. Here, an image-displaying speed is relatively later than a light-emitting speed due to a liquid crystal response speed of the liquid crystal layer of the display panel 250. The image-displaying speed is a speed at which the image control signal is applied to the display unit 200 to display an image. The light-emitting speed is a speed at which the light source control signal LCS is applied to the backlight assembly 300 to emit light.

Therefore, the light source control signal LCS may be synchronized to be delayed by about the liquid crystal response speed with respect to the image control signal. For example, the light source control signal LCS may be synchronized to be delayed by ⅜ of a frame (i.e., about 3.12 ms) with respect to the image control signal.

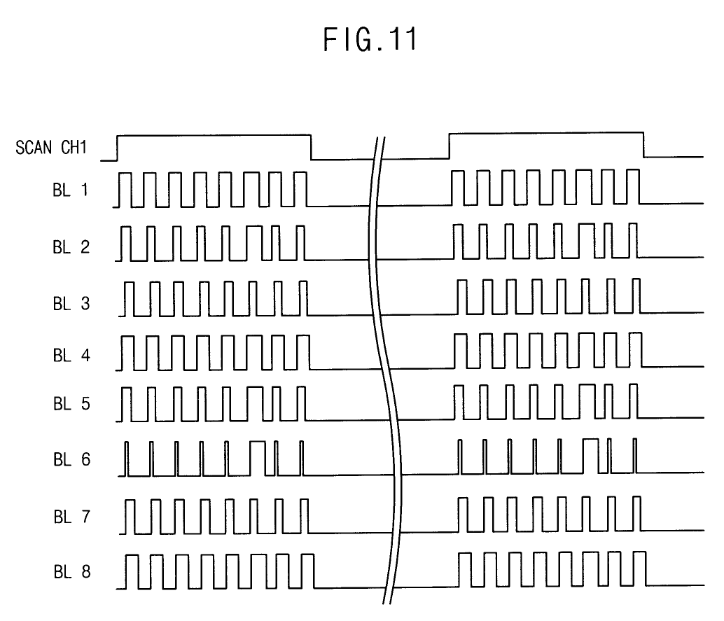

FIG. 11 is a waveform diagram illustrating PWM signals that are applied to each light source block BL1 to BL8, when a first channel signal SCAN CH1 of a first channel area CH1 has a high level. That is, the PWM signals that are applied to each of the first to eighth light source blocks BL1, BL2, BL3, BL4, BL5, BL6, BL7 and BL8 are illustrated, when the first channel signal SCAN CH1 for emitting light through the first channel area CH1 has a high level.

Referring to FIGS. 9 and 11, when the first channel signal SCAN CH1 for emitting light through the first channel area CH1 has a high level, the PWM signals are applied to each of the first to eighth light source blocks BL1, BL2, BL3, BL4, BL5, BL6, BL7 and BL8. In one exemplary embodiment, the PWM signals may be identical to or different from each other in accordance with information of the display image. In another exemplary embodiment, the PWM signals may be partially identical to or different from each other in accordance with the information of the display image. In FIG. 11, the PWM signals are different from each other.

The first channel signal SCAN CH1 has a high level during, for example, ⅜ of a frame, and repeatedly has a high level for every frame. In FIG. 11, the PWM signals have a rectangular shape when the first channel signal SCAN CH1 has a high level. In an alternative exemplary embodiment, the PWM signals may have a rectangular shape when the first channel signal SCAN CH1 has a low level.

In one exemplary embodiment, the backlight assembly 300 may include a plurality of circuits such that the first to eighth light source blocks BL1, BL2, BL3, BL4, BL5, BL6, BL7 and BL8 are driven by the PWM signals when the first channel signal SCAN CH1 has a high level. As a result, the first to eighth light source blocks BL1, BL2, BL3, BL4, BL5, BL6, BL7 and BL8 are driven when the first channel signal SCAN CH1 has a high level.

In the present exemplary embodiment, the first channel signal SCAN CH1 drives the first to eighth light source blocks BL1, BL2, BL3, BL4, BL5, BL6, BL7 and BL8. Alternatively, the second to eighth channel signals may drive the first to eighth light source blocks BL1, BL2, BL3, BL4, BL5, BL6, BL7 and BL8.

As described above, in order to display an image on a portion area of the display panel, the point light sources are individually activated within a required area and, depending on analyzed image data, not all of the point light sources corresponding to the portion area need to be activated, so that power consumption for driving the backlight assembly of the scanning type may be decreased.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A backlight assembly comprising:
a plurality of line light source sections each including a plurality of point light sources disposed along a first direction, the line light source sections disposed along a second direction substantially perpendicular to the first direction; and
a light source driving part controlling each of the line light source sections to individually drive the point light sources, and controlling the line light source sections so that at least one of the line light source sections is sequentially driven along the second direction.

2. The backlight assembly of claim 1, wherein the light source driving part individually drives the point light sources in response to a light source control signal generated through an analysis of external image data.

3. The backlight assembly of claim 1, wherein each of the line light source sections comprises a plurality of unit light-emitting groups arranged along the first direction, the unit light-emitting groups comprising at least one of the point light sources.

4. The backlight assembly of claim 3, wherein each of the point light sources comprises:
a red light-emitting diode emitting red light;
a green light-emitting diode emitting green light; and
a blue light-emitting diode emitting blue light.

5. The backlight assembly of claim 4, wherein each of the unit light-emitting groups comprises:
at least one of the red light-emitting diodes;
at least one of the green light-emitting diodes; and
at least one of the blue light-emitting diodes.

6. The backlight assembly of claim 5, wherein each of the unit light-emitting groups further comprises at least one white light-emitting diode emitting white light.

7. The backlight assembly of claim 3, wherein the point light sources comprise a plurality of white light-emitting diodes emitting white light.

8. The backlight assembly of claim 7, wherein the light source driving section individually drives the unit light-emitting groups so that the point light sources of the unit light-emitting groups emit light of substantially the same luminance, in response to a light source control signal that is generated by analyzing external image data.

9. The backlight assembly of claim 1, wherein the light source driving section controls the line light source sections so that at least one light-emitting line generated from the line light source sections is moved by every one line along the second direction.

10. A display device comprising:
a timing controller outputting an image control signal and a light source control signal in response to an external signal applied from an external device;
a display unit displaying an image in response to the image control signal; and
a backlight assembly comprising:
a plurality of line light source sections each comprising a plurality of point light sources disposed along a first direction, the line light source sections disposed along a second direction substantially perpendicular to the first direction; and
a light source driving part controlling each of the line light source sections to individually drive the point light sources, and controlling the line light source sections so that at least one of the line light source sections is sequentially driven along the second direction.

11. The display device of claim 10, wherein the timing controller comprises an image analysis part that is synchronized with the image control signal to output the light source control signal corresponding to image data included in the external signal.

12. The display device of claim 11, wherein, in response to the light source control signal corresponding to the image data, some of the point light sources are not driven by the light source driving section to reduce power consumption.

13. The display device of claim 10, wherein the display unit comprises:
an image driving part outputting a gate drive signal and a data drive signal in response to the image control signal; and
a display panel displaying an image in response to the gate drive signal and the data drive signal.

14. The display device of claim 13, wherein the display panel comprises:
a first substrate including a gate line formed along the first direction to transmit the gate drive signal, a data line formed along the second direction to transmit the data drive signal, a thin-film transistor electrically connected to the gate and data lines, and a pixel electrode electrically connected to the thin-film transistor;
a second substrate facing the first substrate; and
a liquid crystal layer interposed between the first substrate and the second substrate.

15. The display device of claim 14, wherein the light source control signal is synchronized to be delayed by a response speed of the liquid crystal layer with respect to the image control signal.

16. The display device of claim 15, wherein the light source control signal is synchronized to be delayed by about ⅜ of a frame with respect to the image control signal.

17. A method of driving a display device, the method comprising:
applying an external signal to the display device, the display device including a plurality of line light source sections each having a plurality of point light sources disposed along a first direction, the line light source sections disposed along a second direction substantially perpendicular to the first direction;
generating a light source control signal by analyzing image data of the external signal; and
individually activating the point light sources in response to the light source control signal, and sequentially activating at least one of the line light source sections along the second direction.

18. The method of claim 17, further comprising:
outputting an image control signal in response to the external signal; and
displaying an image on a display unit in response to the image control signal.

19. The method of claim 18, wherein the light source control signal and the image control signal are synchronized with each other.

20. The method of claim 19, wherein the light source control signal and the image control signal are synchronized with at least one of the frequencies of about 60 Hz and about 120 Hz.

21. The method of claim 19, wherein the light source control signal is synchronized to be delayed by a response speed of a liquid crystal layer of the display unit with respect to the image control signal.

22. The method of claim 19, wherein displaying the image on the display unit comprises:
outputting an image drive signal through an image driving section of the display unit in response to the image control signal; and
displaying the image on a display panel of the display unit in response to the image drive signal.

23. The method of claim 22, wherein displaying the image on the display panel of the display unit comprises:
displaying an image on a display area corresponding to at least one line light source section that is activated; and
decreasing a light transmittance ratio of a liquid crystal layer of the display panel corresponding to an interference area adjacent to the display area.

24. The method of claim 17, wherein the light source control signal is a pulse width modulation signal controlling a luminance level of light generated from the point light sources.

25. The method of claim 17, wherein sequentially activating at least one of the line light source sections along the second direction comprises emitting the line light source sections so that at least one light-emitting line of the line light source sections is moved by every one line along the second direction.

26. The method of claim 17, wherein each of the point light sources comprises:
a red light-emitting diode emitting red light;
a green light-emitting diode emitting green light; and
a blue light-emitting diode emitting blue light.

27. The method of claim 17, wherein each of the point light sources comprises a white light-emitting diode emitting white light.

28. The method of claim 17, wherein individually activating the point light sources in response to the light source control signal includes not activating at least some of the point light sources to reduce power consumption.
